(19) United States
(12) Patent Application Publication
(10) Pub. No.: US 2010/0183268 A1
(43) Pub. Date: Jul. 22, 2010

(54) BI-DIRECTIONAL OPTICAL SUBASSEMBLY WITH A WDM FILTER ATTACHED TO A CAP AND A METHOD TO ASSEMBLE THE SAME

(75) Inventors: Toshiaki KIHARA, Yokohama-shi (JP); Hiromi NAKANISHI, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka-shi (JP)

(21) Appl. No.: 12/688,262

(22) Filed: Jan. 15, 2010

(30) Foreign Application Priority Data
Jan. 16, 2009 (JP) 2009-007643

(51) Int. Cl. G02B 6/36

(52) U.S. Cl. 385/93; 385/92

(57) ABSTRACT

A bi-directional optical subassembly (BOSA) with a unique arrangement to set the WDM filter is disclosed. The BOSA includes the stem and the lens cap. The stem mounts both the LD and the PD. While, the lens cap provides, in addition to the condenser lens, a structure to set the WDM filter in a top center thereof. The WDM filter is set in the lens cap with a present angle to the primary surface of the stem when the lens cap is fixed to the stem. Assembling the lens cap with the stem, the relative optical alignment between the LD, the PD and the WDM filter is performed.

### CROSS REFERENCE TO RELATED APPLICATIONS

The present application is related to the following commonly-assigned U.S. patent applications: U.S. Ser. No. 12/430,520, entitled: BI-DIRECTIONAL OPTICAL MODULE INSTALLING LIGHT-EMITTING DEVICE AND LIGHT-RECEIVING DEVICE IN SIGNAL PACKAGE; and U.S. Ser. No. 11/905,505, entitled: BI-DIRECTIONAL OPTICAL MODULE WITH A POLARIZATION INDEPENDENT OPTICAL ISOLATOR; which are hereby incorporated by reference in their entirety.

### BACKGROUND OF THE INVENTION

1. Field of the Invention

The present invention relates to a bi-directional optical subassembly, in particular, the invention relates to a bi-directional optical subassembly (hereafter denoted as BOSA) that installs a semiconductor laser diode (hereafter denoted as LD) and a semiconductor photodiode (hereafter denoted as PD) in a common coaxial CAN package and also installs a wavelength division multiplexing (hereafter denoted as WDM) filter in the CAN package.

2. Related Prior Art

Recent optical access network represented by the fiber to the home (FTTH) has aggressively introduced the passive optical network (PON) system because the PON system may realize a higher speed and a larger capacity communication with a reasonable cost. The PON system uses a bi-directional communication on a single fiber, which may decrease a number of fibers to be installed in the system, and shares the single fiber with a plurality of subscribers. Thus, the PON system may reduce the cost of the communication system as that using the metal cables. According to the PON system, two or three optical signals each having wavelengths of 1.31 μm, 1.49 μm and/or 1.55 μm, respectively, propagate within the signal fiber.

A BOSA practically installed within the PON system is necessary to couple the light emitted from the LD optically with the fiber and also to couple the other light provided from the single optical fiber with the PD. One type of the BOSA installs the LD and the PD within a coaxial CAN package in addition to a WDM filter that reflects the light coming from the LD toward the optical fiber, while transmits the other light provided from the optical fiber to the PD. Thus, the WDM filter in the primary surface thereof is set by 45° with respect to the primary surface of the package where the LD and the PD are mounted thereon. Various techniques to mount the WDM filter by the angle 45° have been proposed in prior arts.

For instance, a Japanese Patent Application published as JP-2004-271921A has disclosed an arrangement shown in FIG. 4A where the LD 14 is mounted to the stem 13 through the sub-carrier 15 such that the optical axis thereof is aligned in parallel to the primary surface 13a of the stem 13. The light coming from the LD 14 is reflected by the WDM filter 16 so as to enter the optical fiber F. That is, the WDM filter is assembled with the surface 16a of the sub-carrier 15 such that the primary surface 16a of the WDM filter at which the light coming from the LD 14 is reflected makes a preset angle with respect to the primary surface 16a.

The prior application mentioned above has also disclosed another arrangement within the package shown in FIG. 4B. This modified arrangement forms a portion 13b extending from the primary surface 13a of the stem 13 to set the WDM filter thereon such that the light from the LD 14 on the sub-carrier 15 enters the optical fiber F. The portion 13b has an inclined surface 13c that makes a preset angle with respect to the primary surface 13a, and the WDM filter 16 is set on this inclined surface 13c.

Even in respective arrangements shown in FIGS. 4A and 4B, the WDM filter 16 is necessary to be firstly aligned in the angle thereof relative to the optical axis of the LD 14 so as to guide the light emitted from the LD 14 toward the optical fiber F, and to align the lens 12a secondly so as to enter the light reflected by the WDM filter 16 in the optical fiber F. The arrangement shown in FIG. 4A fixes the WDM filter 16 onto one surface 15a of the LD carrier 15, accordingly, the first alignment above mentioned may be carried out by rotating the LD 14 on the LD sub-carrier 15, and the second alignment may be performed by positioning the lens cap 12 on the primary surface 13a of the stem 13. While, in the arrangement shown in FIG. 4B, the first alignment may be done by rotating the sub-carrier 13 for the WDM filter 16 on the primary surface 13a and the second alignment may be also performed by adjusting the position of the lens cap 12 on the stem 13. Two-steps alignment is inevitable in each case.

### SUMMARY OF THE INVENTION

An aspect of the present invention relates to an arrangement of a bi-directional optical subassembly that optically couples with an external optical fiber and comprises an LD, a PD, a WDM filter and a coaxial CAN package including a cap and a stem. The LD emits first light with a first wavelength toward an external fiber. The PD receives second light with a second wavelength different from the first wavelength provided from the external fiber. The WDM filter reflect the first light coming from the LD toward the external fiber; while, transmits the second light coming from the external fiber toward the PD. The LD, the PD, and the WDM filter are mounted on the primary surface of the stem and air-tightly sealed within a space formed by the cap and the stem. A feature of the present arrangement is that the WDM filter is attached to the cap with a preset angle to the primary surface of the stem. The cap of the present invention may have a hollow with a slant surface inclined with the preset angle to the primary surface of the stem, in which the WDM filter is attached to the slant surface of the hollow.

Another aspect of the present invention relates to a method to assemble the bi-directional optical subassembly. The method includes steps of: (a) mounting the LD and the PD on the stem, (b) attaching the WDM filter to the cap, where the stem and the cap constitute a coaxial CAN package, (c) optically aligning the cap with the stem, and (d) fixing the cap to the stem. A feature of the invention is that the optical alignment of the cap includes steps of (c1) viewing an image of an active layer of the LD through the WDM filter, (c2) viewing an image of an sensitive are of the PD through the WDM filter, and (c3) positioning the cap on the stem such that the image of the active layer of the LD overlaps with the image of the sensitive area of the PD on the WDM filter.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a partial cross section showing an embodiment of a bi-directional optical subassembly according to the present invention;

FIG. 2 is a partial cross section showing another embodiment of a bi-directional optical subassembly according to the present invention;

FIGS. 3A and 3B illustrate a lens cap installed in the bi-directional optical subassembly shown in FIGS. 1 and 2; and

FIGS. 4A and 4B are cross sections of a conventional BOSA.

### DETAILED DESCRIPTION OF PREFERRED EMBODIMENTS

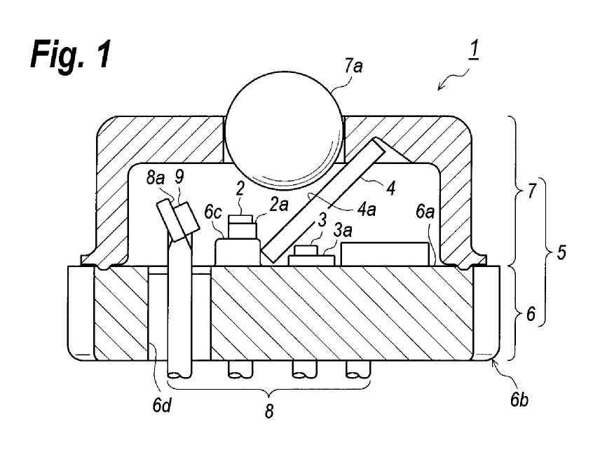

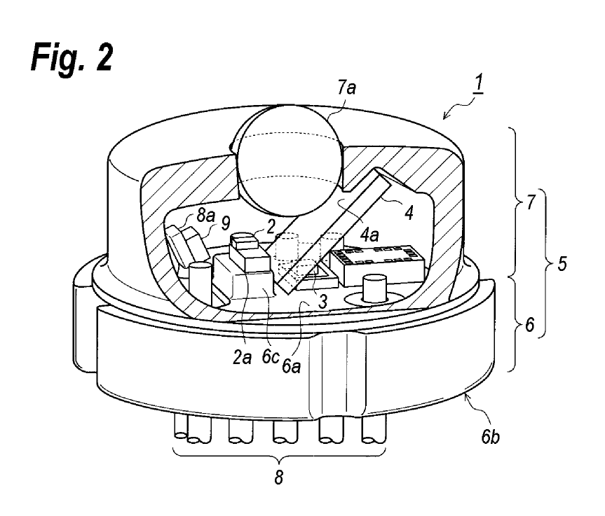

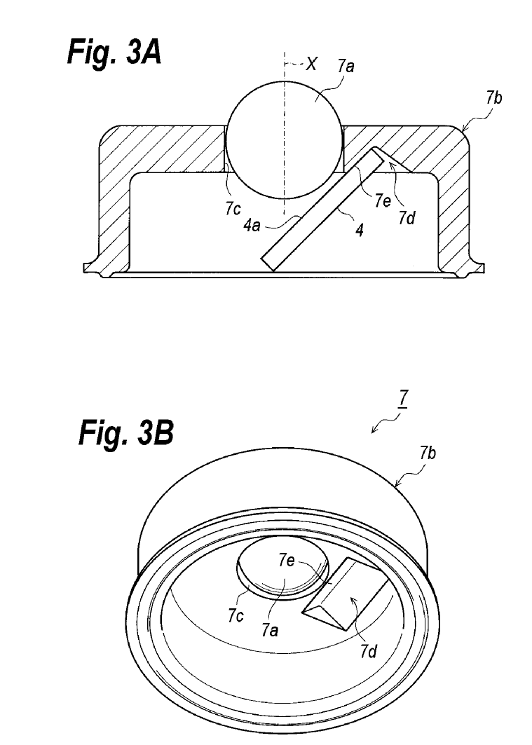

FIGS. 1 and 2 illustrate a BOSA according to the present invention, in which FIG. 1 is a cross section of the BOSA; while, FIG. 2 is a partial cross section of the BOSA. FIGS. 3A and 3B each shows a lens cap 7b of the BOSA shown in FIGS. 1 and 2, in which FIG. 3A is a cross section of the lens cap 7b; while, FIG. 3B is a perspective view of the lens cap 7b.

The BOSA according to the present embodiment shown in FIGS. 1 and 2 has the LD 2, the PD 3 and the WDM filter 4 within the coaxial CAN package 5. The LD 2 emits light with a wavelength of 1310 nm toward the external optical fiber, and is mounted on the primary surface 6a of the stem 6 through the heat sink 2a. The LD 2 may be a type of the distributed feedback (DFB) LD. The optical axis of the LD 2, along which the light emitted from the LD propagates, is substantially in parallel with the primary surface 6a. The PD 3 receives light with a wavelength of, for instance, 1490 nm different from that of the light emitted from the LD 2, and is also mounted on the primary surface 6a of the stem 6 through the sub-mount 3a.

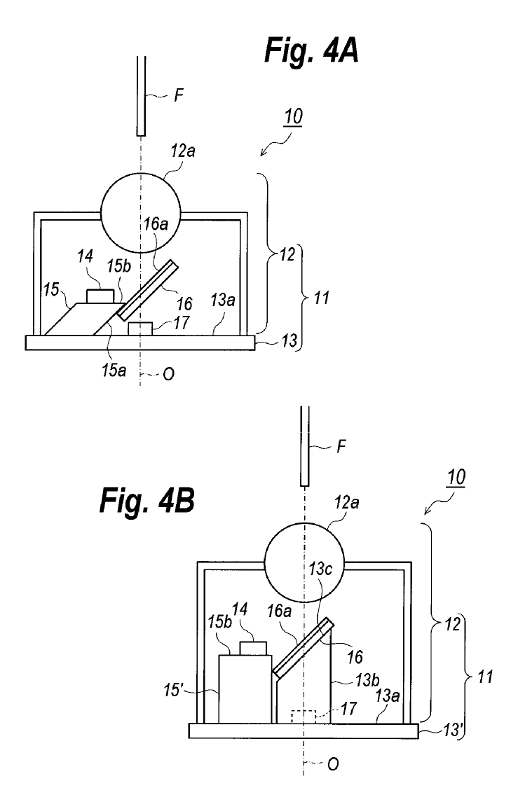

The WDM filter 4 reflects the light coming from the LD 2 toward the external optical fiber; while, at the same time, the other light provided from the external optical fiber transmits toward the PD 3. This WDM filter 4 is set within the CAN package 5 so as to make a preset angle to the primary surface 6a of the stem 6. In a conventional BOSA as shown in FIGS. 4A and 4B, the WDM filter is mounted on a surface 15a (13c) of the sub-carrier 15 (13b); while, the BOSA 1 according to the present embodiment has the WDM filter 4 is fixed to the lens cap 7, which is one of specific features of the present BOSA 1.

The CAN package of the present embodiment includes the stem 6 with the primary surface 6a on which the LD 2 and the PD 3 are mounted and the lens cap 7 provided with a condenser lens 7a. The lens cap 7 is assembled with the stem 6 to seal the devices; the LD 2, the PD 3, the WDM filter 4 and so on, air-tightly on the primary surface 6a. The LD 2 is mounted on the heat sink 2a, and the heat sink 2c is set on the mesa 6c that protrudes from the primary surface 6a. Although not explicitly illustrated in FIGS. 1 and 2, the primary surface 6a mounts, in addition to the LD 2 and the PD 3, a pre-amplifier IC for amplifying a signal generated by the PD 3 and bypass capacitors to reduce noise caused in power supply lines to the LD 2, the PD 3 and the pre-amplifier.

The stem 6 also provides a plurality of lead pins 8. These lead pins 8 pass the through holes 6d as filling the gap with seal glass. One of lead pins 8a mounts the monitor PD 9 on a surface 8a in a top portion thereof. The monitor PD 9 monitors light emitted from the back facet of the LD 2. In order to prevent the light reflected by the surface of the monitor PD 9 from returning the LD 2, the surface 8a where the monitor PD 9 is mounted thereon is slightly tilted, by about 5° to 10°, with respect to the optical axis of the LD 2.

The lens cap 7, as illustrated in FIGS. 3A and 3B, includes the condenser lens 7a and the shell 7b to hold the lens 7a. The shell 7b may be formed by, for instance, machining or stamping the metal sheet. The lens 7a is set in an aperture 7c on a top center portion of the shell 7b with a seal glass. The shell 7b is assembled with the stem 6 by the resistance welding.

The ceiling of the shell 7b provides a hollow 7d with a slant surface 7e to attach the WDM filter 4 thereto. The slant surface 7e has an angle of 45° to the primary surface 6a when the lens cap 7a is assembled with the stem 6. Thus, the WDM filter 4 in the surface 4a thereof may have the preset angle with respect to the optical axis of the LD 2, that of the PD 3 and also that X of the lens 7a as it is attached to the slant surface 7e. The WDM filter 5 may be attached on the slant surface 7e with a low-melting glass or an ultraviolet curable resin after the lens 7a is set in the aperture 7c with a seal glass.

A BOSA with a WDM filter generally sets the WDM filter first and then aligns the LD such that the light emitted from the LD enters the optical fiber through the condenser lens. That is, two steps of optical alignments are necessary in the conventional BOSA. While, in the BOSA according to the present embodiment, because the WDM filter is attached to the shell 7b and this shell 7b is to be assembled with the stem 6, the optical alignment of the LD 2 is necessary only to align the shell 7b on the stem 6, which may effectively reduce a process time for the optical alignment. Specifically, the optical alignment for the LD 2 according to the present arrangement of the BOSA may be carried out by aligning the shell 7b so as to overlap the light-emitting layer of the LD 2 and the light-sensitive area of the PD 3 each viewed through the WDM filter 4 at the position where the lens is to be set.

Thus, the BOSA 1 according to the present embodiment may decrease the process time to align the devices optically, which may effectively reduce the cost of the BOSA 1. In the conventional BOSA shown in FIGS. 4A and 4B, a device such as sub-carrier for the LD is necessary to mount the WDM filter on a slant surface of the device. Such a sub-carrier may be formed by grinding, polishing and so on. On the other hand, the present BOSA provides, to mount the WDM filter, the shell that is formed by machining or cutting.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A bi-directional optical subassembly optically coupled with an external optical fiber, comprising:
an LD to emit first light to said external fiber;
a PD to receive second light provided from said external optical fiber;
a WDM filter to reflect said first light and to transmit said second light; and
a coaxial CAN package including a stem and a cap to form a cavity where said LD, said PD, and said WDM filter are mounted on said stem in said cavity,
wherein said WDM filter is fixed to said lens cap.

2. The bi-directional optical subassembly of claim 1,
wherein said WDM filter has a primary surface inclined by a preset angle with respect to a primary surface of said stem.

3. The bi-directional optical subassembly of claim 1,
wherein said cap provides a lens to concentrate said first light and said second light, said lens being held in a top center of said cap.

4. The bi-directional optical subassembly of claim 3,
wherein said cap further provides a hollow with a slant surface,
wherein said slant surface is inclined with said preset angle to said primary surface of said stem and mounts said WDM filter thereon.

5. The bi-directional optical subassembly of claim 1,
further comprising a monitor PD and a plurality of lead pins in said stem,
wherein said monitor PD monitors light emitted from said LD and is mounted on a top portion of one of said lead pins.

6. The bi-directional optical subassembly of claim 5,
wherein said top portion of said one of said lead pins has a surface inclined to an optical axis of said LD, said monitor PD being mounted on said inclined surface of said one of lead pins.

7. A method to assembly a bi-directional optical subassembly that comprises an LD, a PD and a WDM filter in a coaxial CAN package including a stem and a cap, said method comprising steps of:
mounting said LD and said PD on said stem;
attaching said WDM filter to said cap; and
aligning said cap with said stem optically; and
fixing said cap to said stem.

8. The method of claim 7,
wherein said step to align said cap including steps of:
viewing an image of an active layer of said LD through said WDM filter;
viewing an image of a sensitive area of said PD through said WDM filter; and
positioning said cap on said stem such that said image of said active layer of said LD overlaps with said image of said sensitive area of said PD overlap on said WDM filter.

9. The method of claim 7,
wherein said step of fixing said cap to said stem is carried out by resistance welding.
